(19) United States
(12) Patent Application Publication
(10) Pub. No.: US 2017/0142962 A1
(43) Pub. Date: May 25, 2017

(54) METHODS AND SOLUTIONS INCLUDING ADDITIVES AND STABILIZERS FOR KILLING OR DEACTIVATING SPORES

(71) Applicant: EP Technologies LLC, Akron, OH (US)

(72) Inventors: Tsung-Chan Tsai, Worthington, OH (US); Sameer Kalghatgi, Copley, OH (US); James Ferrell, Tallmadge, OH (US); Shirley Zhu, Cleveland Heights, OH (US); Robert L. Gray, Kent, OH (US)

(21) Appl. No.: 15/358,220

(22) Filed: Nov. 22, 2016

Related U.S. Application Data
(60) Provisional application No. 62/258,840, filed on Nov. 23, 2015.

(51) Int. Cl. A01N 25/22; A01N 59/00

(52) U.S. Cl. CPC A01N 25/22; A01N 59/00

(57) ABSTRACT

Exemplary methods and systems for killing or deactivating spores include applying a fluid containing an additive to a surface containing a spore; and applying direct or indirect plasma to the surface for a period of time.

### RELATED APPLICATIONS

The present invention claims priority to and the benefits of U.S. Provisional Patent Application Ser. No. 62/258,840 filed on Nov. 23, 2015 and titled METHODS AND SOLUTIONS INCLUDING ADDITIVES AND STABILIZERS FOR KILLING OR DEACTIVATING SPORES, which is incorporated herein by reference in its entirety.

### TECHNICAL FIELD

The present invention relates generally to methods for killing or deactivating bacterial spores.

### BACKGROUND OF THE INVENTION

Spore formation is a sophisticated mechanism by which some Gram positive bacteria survive conditions of external stress and nutrient deprivation by producing a multi-layered protective capsule enclosing their dehydrated and condensed genomic DNA. When such bacterial spores encounter a favorable environment, germination can take place enabling the bacteria to reproduce, and, in the case of pathogenic species, release toxins to cause disease. Bacterial spores possess a coat and membrane structure that is highly impermeable to most molecules that are toxic to the spores. Therefore, spores are highly resistant to damage by heat, radiation, and many of the commonly employed anti-bacterial agents and processes, and generally can only be destroyed by some severe chemical procedures including bleach, oxidizing vapors such as hydrogen peroxide, chlorine dioxide and aqueous ozone as ozone vapor is not efficacious against spores.

People receiving medical care in hospitals and long term care facilities can acquire serious infections called healthcare-associated infections (HAIs). While most types of HAIs are declining, one—caused by the germ Clostridium difficile, (“C. diff”)—remains at historically high levels. C. diff is linked to 14,000 American deaths each year. Those most at risk are people, especially older adults, who take antibiotics and receive long term medical care.

C. diff is an anaerobic, Gram positive bacterium. Normally fastidious in its vegetative state, it is capable of sporulating when environmental conditions no longer support its continued growth. The capacity to form spores enables the organism to persist in the environment (e.g., in soil and on dry surfaces) for extended periods of time.

Current methods of killing or deactivating C. diff include applying bleach, liquid solutions containing hydrogen peroxide, and other biocidal compounds, and/or ultraviolet radiation (UV) to C. diff for a period of time longer than 3 minutes.

Anthrax spores, Bacillus anthracis (“anthrax”) is the pathogenic organism that causes anthrax. Anthrax is a disease that is frequently fatal due to the ability of this bacterium to produce deadly toxins. Anthrax also forms spores. Inhalation of anthrax spores is frequently fatal, particularly if treatment is not started prior to the development of symptoms.

Anthrax spores are also among the most difficult spores to kill or deactivate. Present methods of killing or deactivating anthrax spores involve using pressurized steam at elevated temperatures, or topical treatment with highly caustic concentrated sodium hypochlorite solutions or certain disinfecting foam products.

One of the reasons it is very difficult to kill or deactivate dry spores is due to their tendency to aggregate and form multilayered structures. In addition, the dry spores are extremely hydrophobic and adhere to surfaces and skin very strongly, making it very difficult to mechanically remove them.

U.S. Pat. No. 6,706,243 (“the '243 patent”) titled Apparatus and Method for Cleaning Particulate Matter And Chemical Contamination From a Hand and U.S. Pat. No. 7,008,592 (“the '592 patent”) titled Decontamination Apparatus And Method Using An Activated Cleaning Fluid Mist disclose examples of activating fluids that contain hydrogen peroxide by passing the fluids through a plasma generated by an AC arc as a means for killing bacteria on hands and objects. The '592 patent provided examples of activating hydrogen peroxide solutions containing 3.0 percent hydrogen peroxide, 1.5 percent hydrogen peroxide, 0.75 percent hydrogen peroxide, 0.3 percent hydrogen peroxide, and 0 percent hydrogen peroxide solutions (water) for their effect against bacteria, which is much easier to kill or deactivate than spores. After contacting the specimen with activated solution of 0.3 percent hydrogen peroxide, the culture showed slight growth of bacteria and the 0.0 percent hydrogen peroxide solution (water) showed significant growth of the bacteria culture, and thus, the '592 patent demonstrated no efficacy in killing bacteria with water absent hydrogen peroxide. In addition, spraying a mist of hydrogen peroxide, such as 3 percent or 1.5 percent, is undesirable. According to the Agency of Toxic Substances & Disease Registry, “Vapors, mists, or aerosols of hydrogen peroxide can cause upper airway irritation, inflammation of the nose, hoarseness, shortness of breath, and a sensation of burning or tightness in the chest.” In addition, “exposure to high concentrations can result in severe mucosal congestion of the trachea and bronchi and delayed accumulation of fluid in the lungs.” The '592 patent appears to suggest a user wear a mask or other filter to avoid inhaling the mist. See, col. 8, lines 44-48. The OSHA permissible exposure limit is 1 ppm (averaged over an 8-hour work shift. According to the AIHA ERPG-2 (emergency response planning guideline), the maximum airborne concentration below which it is believed that nearly all individuals could be exposed for up to an hour without experiencing or developing irreversible or other serious health effects or symptoms which could impair an individual's ability to take protective action is 50 ppm. Accordingly, activating fluids that contain hydrogen peroxide, such as, the 3 percent hydrogen peroxide disclosed in the '243 patent and '592 patent and dispersing them as a vapor or mist may not be advisable.

In addition, all of the examples in the '243 patent and the '592 patent utilize a non-thermal AC arc to generate plasma. Non-thermal AC arcs produce plasma using bare metal electrodes draw a high currents, typically in the range of about 1 to 100 amps. The temperature in the vicinity of the plasma may be greater than 200° C. Plasma temperatures in this range generate different species than plasma temperatures that are near room temperature. For example, it is believed that any ozone (O₃) generated with higher temperature plasma reacts with generated NO immediately after generation to form NO₂ which quenches any ozone formed. In addition, it is believed that various additives may be affected by the temperatures. For example, it is believed that volatile additives such, as, for example, alcohol will quickly evaporate with these temperatures. Further, such evaporation is likely to be inconsistent.

### SUMMARY

Exemplary methods and solutions for killing or deactivating spores are disclosed herein, An exemplary solution for killing or deactivating a spore includes water and a stabilizer. The solution is activated by a plasma gas to activate the solution. The plasma gas is generated in an ozone generation mode and the activated solution is activated to an activation level that is sufficient to kill or deactivate one or more spores. The activated solution remains at an activation level that is sufficient to kill or deactivate one or more spores for at least about 30 seconds.

An exemplary method of killing or deactivating a spore includes preparing an aqueous solution including at least one additive. The aqueous solution contains less than 0.3% H2O2 prior to being converted to an activated solution by exposing the aqueous solution to a plasma. The activated solution is applied to a surface containing one or more dry spores for a period of time.

Another exemplary solution for killing or deactivating a spore includes water; at least 0.75% by volume of a stabilizer; and less than 10% by volume of an additive. The one or more of the water, stabilizer and additive are activated by a plasma gas generated in an ozone generating mode and the one or more of the water, stabilizer and additive remain activated to a level sufficient to kill one or more spores for at least 30 seconds.

Yet another exemplary solution for killing or deactivating a spore includes water; at least 0.75% by weight of an alcohol; and less than 10% by weight of an additive and one or more of the water, stabilizer and additive are activated by a plasma gas that is operated in an ozone generating mode.

Another exemplary method of killing or deactivating a spore includes applying a fluid comprising an additive to a dry surface containing one or more dry spores; and applying plasma generated in an ozone generating mode to the surface for a period of time.

Another exemplary method of killing or deactivating a spore includes providing a fluid and additive that contains less than about 0.3 percent by volume of H2O2 and exposing a mist or vapor of the fluid and additive to plasma generated in an ozone generating mode to activate the mist or vapor. The activated mist or vapor is applied to a surface containing one or more dry spores for a period of time whereby the spores are killed or deactivated.

### BRIEF DESCRIPTION OF THE DRAWINGS

These and other features and advantages of the present invention will become better understood with regard to the following description and accompanying drawings in which:

FIGS. 1 and 1A illustrate exemplary systems and a method for killing or deactivating spores;

FIGS. 2 and 2A illustrate exemplary systems and a method for killing or deactivating spores;

FIGS. 3 and 3A illustrate exemplary systems and a method for killing or deactivating spores;

FIG. 4 illustrates exemplary systems for producing plasma activated mist or vapor and collecting the activated mist or vapor in liquid form;

FIG. 4A illustrates an exemplary methodology for killing or deactivating spores;

FIG. 5 shows the efficacy of ethanol (EtOH) and hydrogen peroxide (H₂O₂) as additives for killing or deactivating spores;

FIG. 6 shows the efficacy of different concentrations of EtOH as additives for killing or deactivating spores;

FIG. 7 shows the efficacy of different concentrations of H₂O₂ and sodium nitrite (NaNO₂) as additives for killing or deactivating spores;

FIG. 8 shows the efficacy of various acids as additives for killing or deactivating spores;

FIG. 9 shows the efficacy of various concentrations of citric acid as additives for killing or deactivating spores;

FIG. 10 shows the efficacy of 1% grape seed oil as an additive in water for killing or deactivating spores;

FIG. 11 shows the efficacy of EtOH as a vapor additive for killing or deactivating spores;

FIG. 12 shows the efficacy of EtOH as a mist additive for killing or deactivating spores;

FIG. 13 shows the effects of time on the efficacy of water and EtOH plasma activated solutions to kill or deactivate spores;

FIG. 14 shows the effects of time on the efficacy of water or EtOH plasma activated liquids collected from water or EtOH plasma activated mist to kill or deactivate spores; and

FIG. 15 shows the effects of time on the efficacy of activated water and EtOH on wipes to kill or deactivate spores; and

FIG. 16 shows the effects of EtOH as a stabilizer for activated fluids; and

FIG. 17 shows the effects of the plasma mode used to activate fluids for killing or deactivating spores.

### DETAILED DESCRIPTION

Plasmas, or ionized gases, have one or more free electrons that are not bound to an atom or molecule. Plasmas may be generated using a variety of gases including, air, nitrogen, noble gases (He, Ar, Xe, Kr, etc), oxygen, carbon dioxide and mixtures thereof under an applied electric field. In addition, non-thermal cold plasmas provide high concentrations of energetic and chemically active species. They can operate far from thermodynamic equilibrium with high concentrations of active species and yet remain at a temperature that is substantially the same as room temperature. The energy from the free electrons may be transferred to additional plasma components creating additional ionization, excitation and/or dissociation. Fluid that is contacted with plasma becomes “activated” and is referred to herein as plasma activated fluid, and in some embodiments, the plasma-activated fluid is plasma-activated water.

In some embodiments, plasmas may contain superoxide anions [O2^{•-}], which react with H⁺ in acidic media to form hydroperoxy radicals, HOO^{•}; [O₂^{•-}]+[H⁺]→[HOO^{•}]. Other radical species may include OH^{•}, NO^{•}, and NO₂^{•} in aqueous phase or the presence of air or gas. Treating water with plasma results in plasma activated water that may contain concentrations of one or more of ozone, H₂O₂, nitrates, nitrites, peroxynitrite, radicals and other active species.

Activating water with plasma to obtain plasma activated water is shown and described in U.S. Patent Application Publication 2014-0322096 A1, titled Sanitization Station Using Plasma Activated Fluid, and U.S. Patent Application Publication 2014-0100277 A1, titled Solutions and Methods of Making Solutions to Kill or Deactivate Spores Microorganisms, Bacteria and Fungus, both of which are incorporated by reference herein in their entirety. U.S. patent application Ser. No. 13/843,189, entitled Methods and Solutions for Killing or Deactivating Spores, filed on Mar. 15, 2013 and International Patent Application No. PCT/US2014/030361, entitled Methods and Solutions for Killing or Deactivating Spores, filed on Mar. 17, 2014, are also incorporated by reference herein in their entirety.

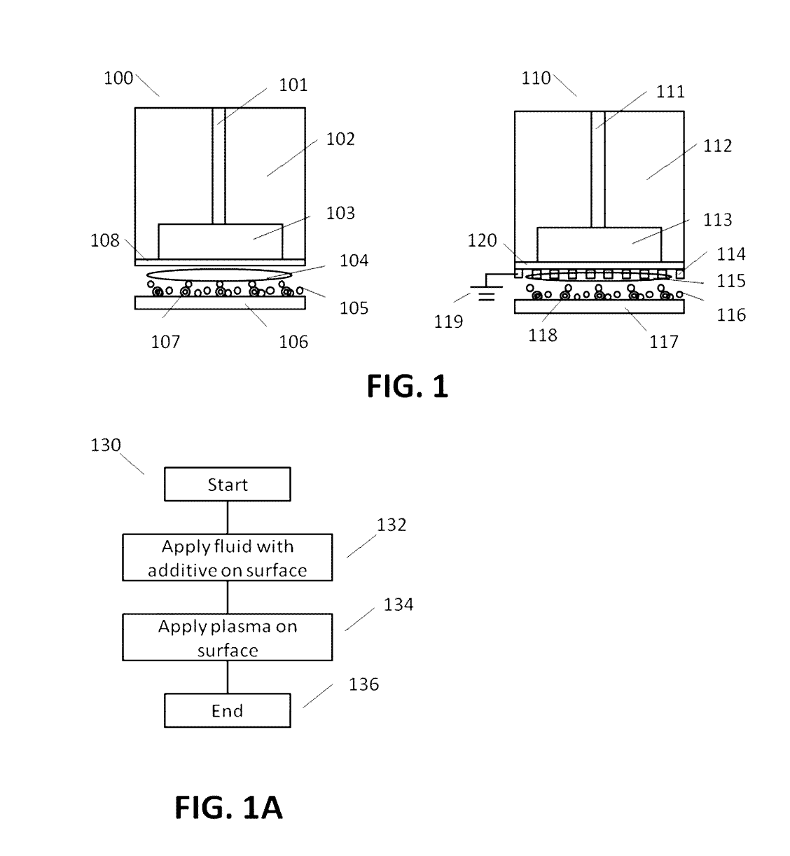

FIG. 1 illustrates an exemplary embodiment of a direct plasma system 100 for killing or deactivating spores 107 on a surface 106. The spore may be, for example, C. diff, anthrax, or other spores. The spores are dry spores, and in some cases, layers of dried spores. The surface may be any surface, including for example, surfaces in a hospital or nursing home like stainless steel, glass, ceramic, laminate, vinyl, granite, wood, linens, curtains, rubber, fabric or plastics. In some embodiments, the surface may be skin or tissue.

The direct plasma system 100 includes a high voltage wire 101 connected to an electrode 103, a dielectric barrier 108 and a housing 102. The direct plasma produced by the direct plasma system 100 is at or about room temperature. The applied voltage is in the range of 3 kV to 30 kV. The high voltage power source to supply high voltage to electrode 103 may be a high frequency AC power source, a pulsed DC power source, a pulsed AC power source or the like. The power supply can be pulsed with a duty cycle of 0-100% and pulse duration of 1 nanosecond up to 1 microsecond. Because of the dielectric barrier 108, the arc formation is avoided and peak amplitude of plasma current is significantly lower and typically less than 1 amp when the AC power source is used

The direct plasma system 100 is used to kill or deactivate spores 107 through the application of a fluid 105 and plasma 104 to the spores 107. In some embodiments, the fluid being activated contains a stabilizer to stabilize the reactive species that kill or deactivate the spores. The stabilizer stabilizes the reactive species and allows for the fluid 105 to continue to kill or deactivate spores after removal of the plasma 104.

FIG. 1 also illustrates an exemplary embodiment of an indirect plasma system 110 for killing or deactivating spores 118 on a surface 117. The spores 118 may be, for example, C. diff, anthrax, or other spores. The spores are dry spores, and in some cases, layers of dried spores. The surface may be any surface, including for example, surfaces in a hospital or nursing home like stainless steel, glass, ceramic, laminate, vinyl, granite, wood, linens, curtains, rubber, fabric or plastics. In some embodiments, the surface may be skin or tissue.

The indirect plasma system 110 includes a high voltage wire 111 connected to an electrode 113, a dielectric barrier 120 and a housing 112. The indirect plasma system 110 also includes ground 119 attached to a screen, perforated material or mesh 114. The indirect plasma system 110 is used to kill or deactivate spores 118 through the application of a fluid 116 and plasma 115 to the spores 118. The indirect plasma produced by the direct plasma system 100 is at or about room temperature. The applied voltage is in the range of 3 kV to 30 kV. The high voltage power source to supply high voltage to electrode 113 may be a high frequency AC power source, a pulsed DC power source, a pulsed AC power source or the like. The power supply can be pulsed with a duty cycle of 0-100% and pulse duration of 1 nanosecond up to 1 microsecond. Because of the dielectric barrier 120, the arc formation is avoided and peak amplitude of plasma current is significantly lower and typically less than 1 amp when the AC power source is used. In some embodiments, the fluid being activated contains a stabilizer to stabilize the reactive species that kill or deactivate the spores. The stabilizer allows for the fluid 105 to continue to kill or deactivate spores after removal of the plasma 104.

FIG. 1A illustrates an exemplary methodology 130 for killing or deactivating a spore using plasma and a fluid containing an additive. The methodology begins at block 132. At block 132 fluid containing an additive is applied to a dry surface containing spores to be treated. In certain embodiments, the fluid includes one or more of a liquid, a vapor, a fog, a mist, a spray, and an aerosol.

In certain embodiments, the fluid includes water. In certain embodiments, the water includes tap water, distilled water, deionized water, potable water, or reverse osmosis water.

In certain embodiments, the additive comprises one or more compounds to reduce the pH of the fluid, increase the supply of reactive oxygen species (ROS), increase the supply of reactive nitrogen species (RNS), and increase the stability of reactive species, such as reactive oxygen and reactive nitrogen species (RONS). Exemplary additives to reduce the pH include acids. Exemplary additives to increase the supply of reactive oxygen species include enzymes and hydrogen peroxide (H₂O₂). If hydrogen peroxide is used, the concentration of hydrogen peroxide of the fluid being activated, is less than about 1% hydrogen peroxide. Exemplary additives to increase the supply of reactive nitrogen species include enzymes, nitrites, and transition metals.

Exemplary additives to stabilize reactive species include alcohols. In certain embodiments, the alcohol includes one or more of ethanol (EtOH), isopropyl alcohol, and n-propyl alcohol.

Other exemplary additives include bioactive oils. In certain embodiments, the nitrite includes sodium nitrite or nitrous acid. In certain embodiments, the bioactive oil includes one or more of cinnamaldehyde, carvacrol, coconut oil, grape seed oil, thyme oil and olive oil. In certain embodiments, the acid includes one or more of acetic acid, citric acid, nitrous acid, nitric acid, and hydrochloric acid (HCl). In certain embodiments, the transition metal includes one or more of zinc and cadmium. In certain embodiments, the enzyme includes one or more of superoxide dismutase and nitrate reductase. Although these additives may not stabilize the species, they act synergistically with the plasma activated fluid.

The additive can be present in the fluid to any extent necessary to provide improved killing or deactivation of spores. Where the additive includes an alcohol, the fluid preferably contains at least about 0.75%, including about 30%, including about 50%, including about 70% or more alcohol. Where the additive is an additive other than an alcohol, the fluid preferably contains no more than about 10% of the additive, including about 1%, including about 0.1%, including about 0.01%, including about 0.001%, and including about 0.0001% of the additive. Where the additive is an alcohol and is being used as a stabilizer, the fluid preferably contains at least about 0.75% of alcohol by volume.

The fluid can be applied to the spores in any form that allows for effective killing or deactivation of the spores. In certain embodiments, the fluid contains electrostatically charged droplets and is applied to the spores as individual droplets. In certain embodiments, the fluid forms a thin film of liquid on the spores. In certain embodiments, the thin film has a thickness of less than about 500 microns, including about 400 microns, about 300 microns, about 200 microns, about 100 microns, or less.

The surface may be any surface, such as, for example, table, a bed, etc. made of polymer, metal, rubber, glass, silicone, fabric material or the like. The surface may be a hard surface or a soft surface, such as, for example, linens, curtains and the like. In addition, the surface may be tissue or skin. After the fluid containing the additive is applied to the surface, the surface is treated with plasma at block 134 (FIG. 1A). The plasma can be either direct or indirect plasma and may be generated using various working gases, such as air, nitrogen, an inert gas, a noble gas or any combinations thereof. The plasma is a non-thermal plasma and can be generated from any type of direct or indirect non-thermal plasma generator, such as a plasma jet, volumetric dielectric barrier discharge (DBD), surface DBD, DBD plasma jet, gliding arc, corona discharge, non-thermal arc discharge, pulsed spark discharge, hollow cathode discharge, or glow discharge.

Treatment time may vary depending on the surface and the spore to be deactivated or killed. In certain embodiments, the surface is treated for about 5 minutes. In certain embodiments, the surface is treated for less than about 5 minutes. In certain embodiments, the surface is treated for less than about 3 minutes. In certain embodiments, the surface is treated for less than about 1 minute. In certain embodiments, the surface is treated for about 30 seconds or less. In certain embodiments, the surface is treated for about 5 seconds or less. In certain embodiments, the surface is treated for about 2 seconds. In certain embodiments, the surface is treated for more than about 5 minutes. After the surface has been treated with plasma, the methodology ends at block 136.

Treating the surface with plasma activates the fluid, such as water, which penetrates the shell of the spore and kills or deactivates the spores. In certain embodiments, the plasma contacts the spores directly between droplets or vapor and creates an opening for the activated fluid to penetrate the shell of the spore to kill or deactivate the spore.

In certain embodiments, the methodology 130 generates one or more reactive species in the fluid. In certain embodiments, the reactive species include one or more of reactive oxygen and reactive nitrogen species. In certain embodiments, the reactive nitrogen species includes peroxynitrite, which has a half-life of around 1 second. The misted fluid has a relatively large surface area compared with non-misted fluid in a container, and the large surface area allows the plasma to activate the misted fluid quickly and more effectively, as higher concentrations of reactive oxygen and nitrogen species such as ozone, hydroxyl radicals, superoxide, singlet oxygen, hydrogen peroxide, nitrites and nitrates are generated. It also allows the generation of peroxynitrite, which almost immediately contacts the spore surface, as opposed to having to migrate through a larger volume of water to make contact with the spores. Thus, peroxynitrite may contact the spore prior to its degeneration. It is desirable to stabilize the reactive species to improve the ability to kill or deactivate the spores and also prolong the activity of the reactive species. In certain embodiments, the fluid includes an additive that stabilizes one or more of the reactive species. In certain embodiments, the fluid includes an additive provides stable sporicidal species after activation by plasma. In certain embodiments, the stabilizing additive is an alcohol. In certain embodiments, the additive stabilizes a reactive oxygen species. In certain embodiments, the additive stabilizes a reactive nitrogen species. In certain embodiments, the additive stabilizes both reactive oxygen and reactive nitrogen species. In certain embodiments, the additive stabilizes peroxynitrite. In certain embodiments, the addition of alcohol to the fluid, such as water, provides stable sporicidal species, such as peroxy acid, after activation by plasma. In certain embodiments, the addition of alcohol to the fluid, such as water, provides stable sporicidal species which is more volatile than alcohol after activation by plasma. When alcohol is used as a stabilizer and plasma is generated in ambient air at atmospheric pressure, the plasma operates in an ozone mode in order to produce stable sporicidal species. The plasma operating in the ozone mode in ambient air conditions includes DBD with a power density lower than 0.25 (W/cm²) and corona discharges.

In the exemplary methodology 130, plasma is applied to the fluid on the surface and activates the fluid. Thus, the short live species immediately contact the spores. Stabilizers provide greater efficacy in such situations, when the plasma source is removed from the fluid as the reactive species last longer and can continue to kill or deactivate spores. In embodiments, where the fluid with an additive is first activated then applied to the surface, stabilizers become more important. It has been discovered that without the use of stabilizers, the life of the reactive species that are effective against spores is very short, such as a few seconds. Thus, it would be difficult to apply the fluid to effectively kill spores absent a stabilizer or absent applying the fluid immediately after activation or simultaneously with the activation.

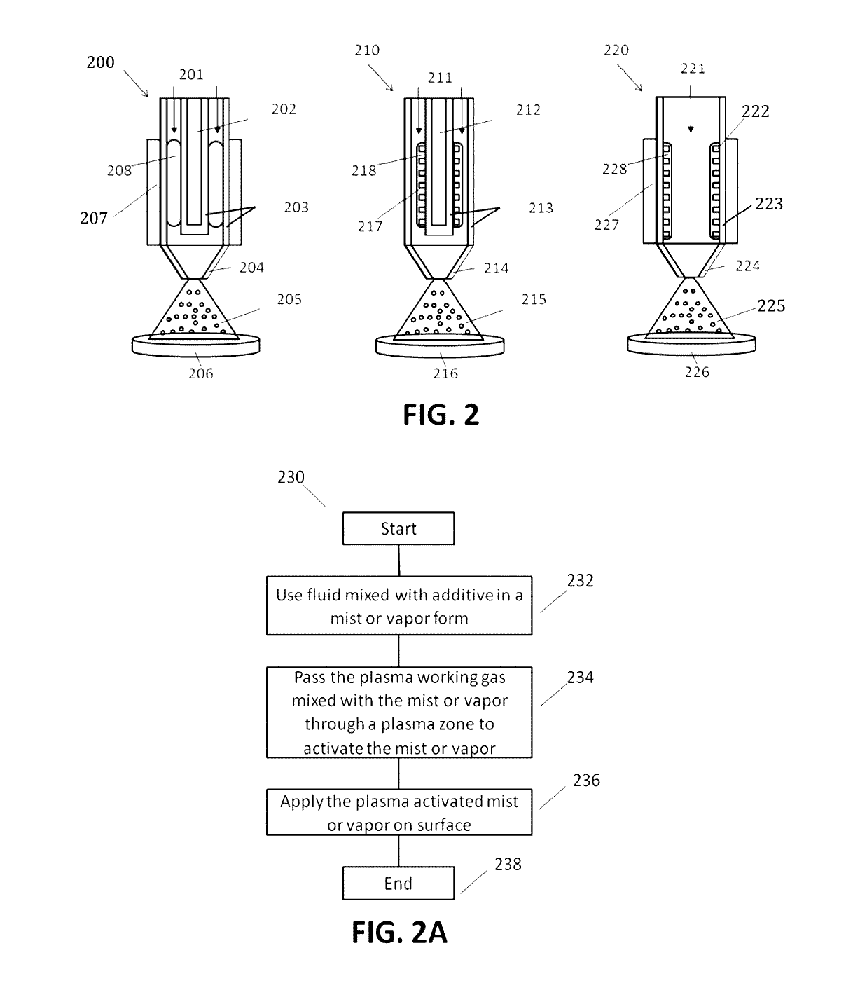

FIG. 2 illustrates exemplary embodiments of cylindrical double-dielectric plasma system 200, and a first 210 and second 220 single-dielectric plasma system for activating fluid to kill or deactivate spores. The spores are dry spores, and in some cases are layers of dry spores. The spore may be, for example, C. diff, anthrax or other spores. The combination of plasma working gas and a fluid containing an additive 201 are added to the double-dielectric plasma system 200. The working gas is the gas used to generate the plasma 208, and can be any of the gases used to generate plasma described above. The plasma system includes a high voltage electrode 202, dielectric materials 203, a ground electrode 207 and a nozzle 204 from which the activated fluid 205 is released onto a contaminated surface 206. The plasma 208 produced is at or about room temperature. The applied voltage is in the range of 3 kV to 30 kV. The high voltage power source to supply high voltage to electrode 202 may be a high frequency AC power source, a pulsed DC power source, a pulsed AC power source or the like. The power supply can be pulsed with a duty cycle of 0-100% and pulse duration of 1 nanosecond up to 1 microsecond. Because of the dielectric barrier 203, the arc formation is avoided and peak amplitude of plasma current is significantly lower and typically less than 1 amp when the AC power source is used. The contaminated surface 206 can be any of the various surfaces described above and can be contaminated with one or more C. diff, anthrax and other spores.

Also shown in FIG. 2 are first 210 and second 220 single-dielectric plasma systems. The first 210 single-dielectric plasma system is similarly configured to the double-dielectric plasma system 200. The combination of a plasma working gas and a fluid containing an additive 211 are added to the first 210 surface plasma system. The working gas is the gas used to generate the surface plasma 218, and can be any of the gases used to generate plasma described above. The first 210 surface plasma system includes a high voltage electrode 212, dielectric materials 213, and a ground electrode 217. In the first 210 surface plasma system, the ground electrode 217 includes a mesh or perforated material through which the plasma 218 is generated only in the vicinity of the ground electrode 217 and the surface of the dielectric material 213. The plasma 218 produced is at or about room temperature. The applied voltage is in the range of 3 kV to 30 kV. The high voltage power source to supply high voltage to electrode 212 may be a high frequency AC power source, a pulsed DC power source, a pulsed AC power source or the like. The power supply can be pulsed with a duty cycle of 0-100% and pulse duration of 1 nanosecond up to 1 microsecond. Because of the dielectric barrier 213, the arc formation is avoided and peak amplitude of plasma current is significantly lower and typically less than 1 amp when the AC power source is used The first 210 single-dielectric plasma system also includes a nozzle 214 from which activated fluid 215 is released onto a contaminated surface 216. The contaminated surface 216 can be any of the various surfaces described above and can be contaminated with one or more C. diff, anthrax and other spores.

The second 220 single-dielectric plasma system is also similarly configured. The combination of plasma working gas and a fluid containing an additive 221 are added to the second 220 single-dielectric plasma system. The working gas is the gas used to generate the plasma 228, and can be any of the gases used to generate plasma described above. The second 220 single-dielectric plasma system includes a high voltage electrode 222, dielectric materials 223, and a ground electrode 227. In the second 220 single-dielectric plasma system, the high-voltage electrode 222 includes a mesh or perforated material through which the plasma 228 is generated in the vicinity of the electrode 222 and the inner surface of the dielectric material 223. The second 220 single-dielectric plasma produced is at or about room temperature. The applied voltage is in the range of 3 kV to 30 kV. The high voltage power source to supply high voltage to electrode 222 may be a high frequency AC power source, a pulsed DC power source, a pulsed AC power source or the like. The power supply can be pulsed with a duty cycle of 0-100% and pulse duration of 1 nanosecond up to 1 microsecond. Because of the dielectric barrier 223, the arc formation is avoided and peak amplitude of plasma current is significantly lower and typically less than 1 amp when the AC power source is used. The second 220 single-dielectric plasma system also includes a nozzle 224 from which activated fluid 225 is released onto a contaminated surface 226. The contaminated surface 226 can be any of the various surfaces described above and can be contaminated with one or more C. diff, anthrax and other spores.

FIG. 2A illustrates an exemplary methodology 230 for killing a spore using plasma. The methodology begins at block 232. At block 232, a fluid mixed with an additive is prepared in mist or vapor form. The fluid may be any fluid such as water, in any of the various forms described above. The additive may contain one or more of an alcohol, H₂O₂, a nitrite, bioactive oil such as cinnamaldehyde, carvacrol, an acid, a transition metal, and an enzyme, including one or more specific examples of these additives described above. If the additive is H₂O₂, the H₂O₂ is less than 1% of the solution. Depending on the additive used, the additive may be present in the fluid at any appropriate concentration, including the concentrations described above.

The methodology continues at block 234. At block 234, a plasma working gas mixed with the mist or vapor is passed through a plasma zone to activate the mist or vapor. The working gas can be any of the working gases described above and the plasma zone is made of non-thermal plasma, which can be generated using any of the plasma generators described above. As described above, in certain embodiments, activation of the mist or vapor with the plasma results in the fluid containing electrostatically charged droplets.

In certain embodiments, activation of the mist or vapor with the plasma results in the production of one or more reactive species including one or more reactive oxygen and reactive nitrogen species. In certain embodiments, the one or more reactive nitrogen species includes peroxynitrite. Because these reactive species help kill or deactivate spores, but otherwise may have a short half-life, in certain embodiments, it is desirable that the mist or vapor includes fluid with an additive that stabilizes one or more of these reactive species, such as an alcohol.

At block 236, the methodology continues with the application of the activated mist or vapor to a surface containing one or more dry spores for a period of time sufficient to kill or deactivate the spores on the surface. After the application of the activated mist or vapor to a surface, the methodology ends at block 238.

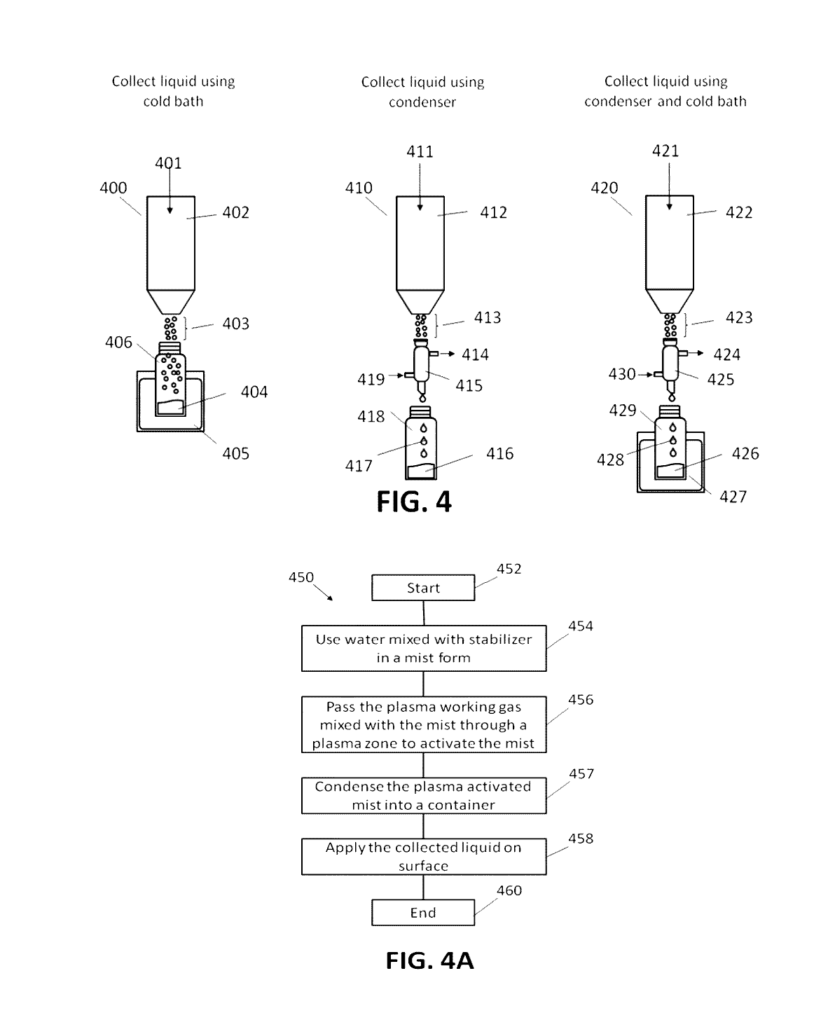

Application of the activated mist or vapor to the surface can result in the fluid forming individual droplets over one or more spores on the surface or can result in the fluid forming a film over one or more spores on the surface. The surface may be any surface, such as the various surfaces described above. Depending on the spore and the surface, the period of time sufficient to kill or deactivate the spore can vary, but generally application periods of time of less than 5 minutes, including about 3 minutes, about 1 minute, and about 30 seconds are sufficient.

Where killing or deactivation of spores relies, at least in part, on the generation of one or more reactive species, because of the short half-life of some species e.g., 1-second, the activated mist or vapor generally needs to be applied to the surface immediately after activation, or activated while on the surface to be treated. Where the mist or vapor includes a fluid with an additive that can stabilize the reactive species the activated mist or vapor may be applied to the surface some period of time after the mist or vapor is activated. Appropriate periods of time after activation include, but are not limited to, greater than about 15 seconds, including at least about 30 seconds, at least about 1 minute, at least about 2 minutes, at least about 3 minutes, and at least about 5 minutes after activation. The activated plasma mist or vapor with the stabilizer can be directly applied to a spore-containing surface after a period of time. In certain embodiments, the activated plasma mist or vapor is collected as a liquid. The liquid can then be applied to a spore-containing surface. In certain embodiments, liquids obtained from plasma activated mists or vapor have greater stability of reactive species than liquids directly activated by plasma and the mist or vapor from which the liquid is collected. In certain embodiments, a liquid containing a stabilizer obtained from plasma activated mist or vapor can be applied to a spore-containing surface greater than 1 minute, including greater than 3 minutes, including greater than 5 minutes after the mist or vapor is activated by plasma. Exemplary systems for generating plasma activated mist or vapor and collecting the plasma activated mist or vapor as a liquid are shown in FIG. 4.

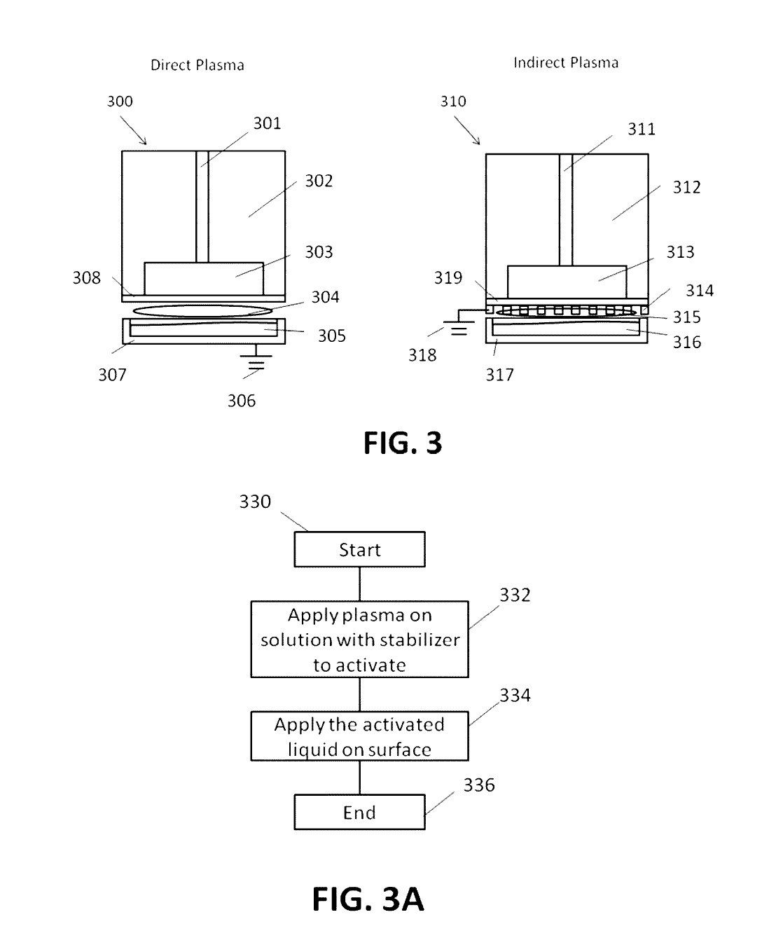

FIG. 3 illustrates an exemplary embodiment of a direct plasma system 300 for killing or deactivating spores using an aqueous solution with an additive 305. The solution may be present in a container 307. The spore may be, for example, C. diff, anthrax or other spores. The spores are dry spores, and in some cases, layers of dried spores.

The direct plasma system 300 includes a high voltage wire 301 connected to an electrode 303, a dielectric barrier 308, a ground 306, and a housing 302. The direct plasma 304 produced is at or about room temperature. Because of the dielectric barrier 308, the arc formation is avoided and peak amplitude of plasma current is significantly lower and typically less than 1 amp when the AC power source is used. The direct plasma system 300 is used to kill or deactivate spores through the application of an aqueous solution with an additive 305, which has been activated by plasma 304, to one or more spores.

FIG. 3 also illustrates an exemplary embodiment of an indirect plasma system 310 for killing or deactivating spores using an aqueous solution with an additive 316. The spores may be, for example, C. diff, anthrax or other spores. The spores are dry spores, and in some cases, layers of dried spores.

The indirect plasma system 310 includes a high voltage wire 311 connected to an electrode 313, a dielectric barrier 319 and a housing 312. The indirect plasma system 310 also includes grounds 314 and 318. The indirect plasma produced is at or about room temperature. The applied voltage is in the range of 3 kV to 30 kV. The high voltage power source to supply high voltage to electrode 313 may be a high frequency AC power source, a pulsed DC power source, a pulsed AC power source or the like. The power supply can be pulsed with a duty cycle of 0-100% and pulse duration of 1 nanosecond up to 1 microsecond. Because of the dielectric barrier 319, the arc formation is avoided and peak amplitude of plasma current is significantly lower and typically less than 1 amp when the AC power source is used. The indirect plasma system 310 uses plasma 315 to activate an aqueous solution with an additive 316 which may be present in a container 317. The activated aqueous solution with an additive 316 can then be used to kill or deactivate spores for a period of time after activation, provided that the additive 316 is a stabilizer.

FIG. 3A illustrates an exemplary methodology 330 for preparing an activated aqueous solution using plasma and applying the activated solution to a surface to kill or deactivate spores. The methodology begins at block 332. At block 332, plasma is applied to an aqueous solution containing a stabilizer to activate the solution. The aqueous solution may also include one or more additives. The plasma is non-thermal plasma and can be generated using any plasma generator with any working gas, such as the generators and working gases described above. The plasma can be applied to the aqueous solution using any combination of indirect and direct plasma systems. The aqueous solution can contain any liquid that can be activated by plasma and used to kill or deactivate spores. In certain embodiments, the aqueous solution includes water. The additive in the aqueous solution can be any additive that can be used with the solution and facilitate the killing or deactivation of spores. In certain embodiments, the additive includes one or more of an alcohol, H₂O₂, a nitrite, a bioactive oil, an acid, a transition metal, and an enzyme, including one or more specific examples of these additives described above. Depending on the additive included, the additive may be present in the aqueous solution at any appropriate concentration, including the concentrations described above.

In certain embodiments, activation of the aqueous solution with the plasma results in the production of one or more reactive species including one or more reactive oxygen and reactive nitrogen species. In certain embodiments, the one or more reactive nitrogen species includes peroxynitrite. Because these reactive species help kill or deactivate spores, but otherwise may have a short half-life, the aqueous solution includes a stabilizer to stabilize one or more of these reactive species, such as an alcohol.

At block 334, the methodology continues with the application of the activated aqueous solution to a surface containing one or more dry spores for a period of time. After the application of the activated aqueous solution to a surface, the methodology ends at block 336.

Depending on the spore and the surface, the period of time the aqueous solution is applied to the surface can vary, but generally application periods of time will be less than 5 minutes, including about 3 minutes, about 1 minute, and about 30 seconds.

Where killing or deactivation of spores relies, at least in part, on the generation of one or more reactive species, because of the short half-life, e.g. 1-second, of some species, the activated aqueous solution generally needs to be applied to the surface immediately after activation. Where the aqueous solution includes an additive or stabilizer which can stabilize the reactive species the activated aqueous solution may be applied to the surface some period of time after the aqueous solution is activated. Appropriate periods of time after activation include, but are not limited to, greater than about 15 seconds, including at least about 30 seconds, at least about 1 minute, at least about 2 minutes, at least about 3 minutes, and at least about 5 or 10 minutes after activation.

FIG. 4 illustrates a cold bath system 400, a condenser system 410, and a condenser and cold bath system 420 for collecting plasma activated mist or vapor, such as plasma activated mist or vapor produced using the systems illustrated in FIG. 2, in the form of a liquid. Regarding the cold bath system 400, the combination of plasma working gas and a fluidic compound with an additive or stabilizer 401 is fed through a plasma mist generator 402. The activated mist 403 is collected as plasma activated liquid 404 in a container 406 which is present in a cold bath 405. Regarding the condenser system 410, the combination of a plasma working gas and a fluidic compound with an additive 411 is fed through a plasma mist generator 412. The activated mist 413 is condensed in a condenser 415 using a coolant, which passes through the condenser 415 through a coolant inlet port 419, and coolant outlet port 414. Condensed droplets 417 of the activated mist 413 are captured as plasma activated liquid 416 in a container 418. Collection can also be carried out using a combination condenser and cold bath system 420. In the condenser and cold bath system 420, a combination of plasma working gas and a fluidic compound with an additive 421 is fed through a plasma mist generator 422. The activated mist 423 is condensed in a condenser 425 using a coolant, which passes through a coolant in port 430, and coolant out port 424. Condensed droplets 428 are captured as plasma activated liquid 426 in a container 429 placed in a cold bath 427.

An exemplary methodology for killing or deactivating spores 450 is illustrated in FIG. 4A, which begins at block 452. At block 454 water mixed with one or more additives, which preferably include a stabilizer, is turned into a mist. The mist and a plasma working gas are passed through the plasma zone to activate the mist at block 456. The plasma activated mist is condensed at block 457 and the condensed liquid is applied to a surface to be treated at block 458. The exemplary methodology ends at block 460.

### EXAMPLES

The following examples illustrate specific embodiments and/or features of the present disclosure. The examples are given solely for the purpose of illustration and are not to be construed as limiting on the present disclosure, as many variations thereof are possible without departing from the spirit and scope of the disclosure.

In the following examples, various treatments were applied to measure the ability of plasma-activated liquids containing various additives to kill or deactivate spores from C. diff bacteria. Briefly, a volume of 10 μl of C. diff spores in sterile water (containing approximately 10⁸ colony forming units (CFUs)/ml) was added onto a sterile stainless steel disc and left to dry for 30 minutes. The contaminated surfaces were then exposed to a treatment described below. After treatment, the killing or deactivation capacity of the treatment was measured by estimating the number of surviving CFUs. Estimation of surviving CFUs was determined by placing the disc in test tubes filled with a neutralizer. The test tubes were sonicated for 1 minute and vortexed for 15 seconds to fully remove spores from the surfaces. The neutralizer solution containing spores was diluted and plated on Brain Heart Infusion Agar supplemented with 0.1% Sodium Taurocholate (BHIT). The agar plates were incubated under anaerobic conditions for 36-48 hours at 37° C. CFUs were estimated based on colony counts on the agar plates following incubation.

### Example 1: EtOH and H₂O₂ Increase the Killing and Deactivation Efficiency of a Plasma Activated Medium

A direct plasma treatment (as shown in FIG. 1) with DBD was used for the testing. The direct DBD was created by an AC sinusoidal voltage power supply with a power scale at 15 (approximately 20 kV peak-to-peak) and a driving frequency of 20.5 kHz. The gap distance between the plasma reactor and the disc was 2 mm. Soil, which consists of bovine serum albumin, bovine mucin, and Tryptone, was added to the stainless steel disc before the addition of spores to simulate the real-world setting where spores are typically present with organic matter including bodily fluids. EtOH or H₂O₂ was added to water to produce different concentration solutions (35% EtOH, 70% EtOH, and 3% H₂O₂). Different volumes (3, 6, 9, and 12 μl) of EtOH, H₂O₂, and water-only solutions were applied to the spore-containing discs. After application, the discs were subjected to DBD treatment for 30 seconds.

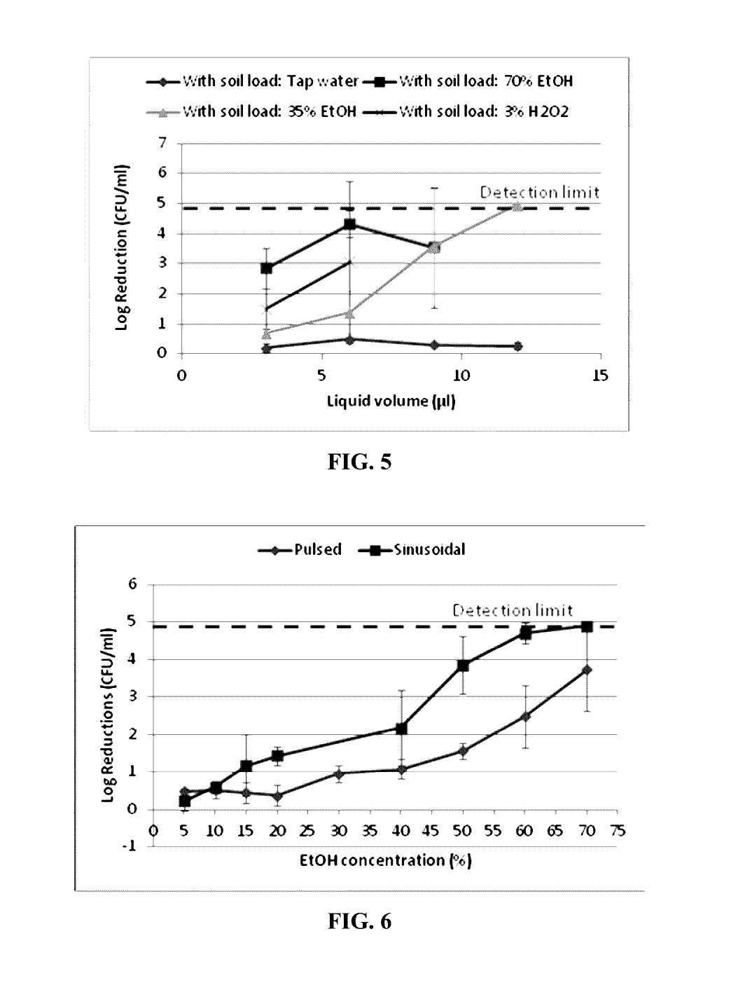

The results are shown in FIG. 5. As shown in FIG. 5, water alone (diamond line) produced a 0.5 log reduction (LR) in the CFUs. Using water-only solutions with the same plasma conditions without the soil led to >4 log reduction (LR). The presence of soil significantly quenched the species produced in the plasma-water system. The use of H₂O₂ or EtOH as additives in the water substantially increased the kill or deactivation efficiency. The addition of 12 μl of the 35% EtOH solution (triangle line) reached a kill or deactivation efficiency at the detection limit. A general trend of increased kill or deactivation efficiency was seen with increased volumes of solution.

### Example 2: Increasing EtOH Concentration Increases Killing or Deactivation Efficiency

A direct plasma treatment (as shown in FIG. 1) with DBD was used for the testing. The direct DBD was created by an AC sinusoidal voltage power supply with a power scale at 15 (approximately 20 kV peak-to-peak) and a driving frequency of 20.5 kHz or a microsecond pulsed power supply which creates discrete voltage bursts at a repetition rate of 3.5 kHz which consist of decaying sinusoidal waveforms with a frequency of 32 kHz and a peak-to-peak voltage of approximately 20 kV. The gap distance between the plasma reactor and the disc was 2 mm. Soil was added to the stainless steel disc before the addition of spores. 12 μl of differing concentrations of EtOH solutions were applied to the spore-containing discs. After application, the discs were subjected to DBD treatment for 30 seconds.

The results are shown in FIG. 6. As shown in FIG. 6, increasing killing or deactivation efficiency was seen with increased EtOH concentration. At a 70% EtOH concentration, and using the sinusoidal voltage power supply (square line), the killing or deactivation efficiency reached the detection limit.

### Example 3: Increasing the Concentration of H₂O₂ Increases Killing or Deactivation Efficiency, but Increasing the Concentration of NaNO₂, Generally does not

A direct plasma treatment (as shown in FIG. 1) with DBD was used for the testing. The direct DBD was created by a microsecond pulsed power supply which creates discrete voltage bursts at a repetition rate of 3.5 kHz which consist of decaying sinusoidal waveforms with a frequency of 32 kHz and a peak-to-peak voltage of approximately 20 kV. The gap distance between the plasma reactor and the disc was 2 mm. Spore inoculum for the stainless steel disc was prepared in 1× Phosphate Buffered Saline and 0.1% Tween (PBST) instead of sterile water. H₂O₂ or NaNO₂ was added to water to produce solutions of differing molarities (1, 10, 100, and 500 mM). 10 μl of each of these solutions was added to the spore-containing discs. After application, the discs were subjected to DBD treatment for 20 seconds.

The results are shown in FIG. 7. As shown in FIG. 7, in two separate trials of the H₂O₂ or NaNO₂ solutions, increasing the concentration of H₂O₂ (diamond and triangle lines) increased the killing or deactivation efficiency. By contrast, other than at the 10 mM concentration, an increased concentration of NaNO₂ (square and crosshatch lines) did not increase the killing or deactivation efficiency. This may be due to the fact that a high concentration of NaNO₂ may lead to an increase in the pH of the solution. These results are consistent with the hypothesis that low pH of a plasma-activated fluid is an important factor in the antimicrobial efficiency. Using water-only solutions with the same plasma conditions without the PBS led to >4 log reduction (LR). The presence of PBS, which exhibits very high ionic strength, significantly quenched the species produced in the plasma-water system.

### Example 4: Acids Increase Killing or Deactivation Efficiency

A direct plasma treatment (as shown in FIG. 1) with DBD was used for the testing. The direct DBD was created by a microsecond pulsed power supply which creates discrete voltage bursts at a repetition rate of 3.5 kHz which consist of decaying sinusoidal waveforms with a frequency of 32 kHz and a peak-to-peak voltage of approximately 20 kV. The gap distance between the plasma reactor and the disc was 2 mm. Spore inoculum for the stainless steel disc was prepared in 1×PBST with soil instead of sterile water. Citric acid, acetic acid, or HCl was added to water to produce 0.0001% to 10% acid solutions. 3 μl of each of these solutions was added to the spore-containing discs. After application, the discs were subjected to DBD treatment for 20 seconds.

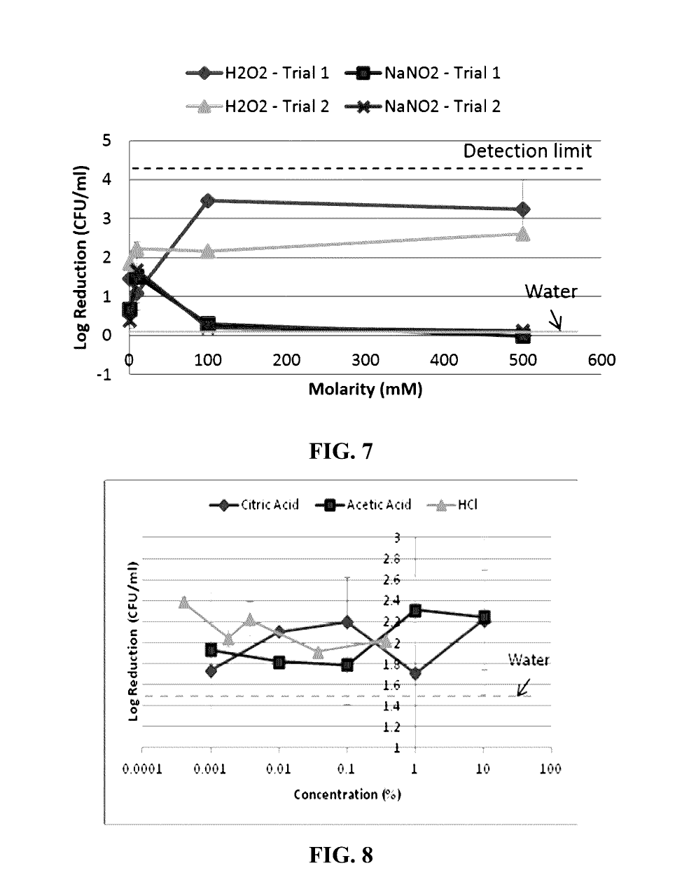

The results are shown in FIG. 8. As shown in FIG. 8, all three of citric acid (diamond line), acetic acid (square line), and HCl (triangle line) increased the killing or deactivation efficiency relative to water alone (dotted line). Surprisingly, even a 0.0001% HCl solution increased killing or deactivation efficiency by approximately 1 log relative to the water solution when soil is present.

### Example 5: Citric Acid Increases Killing or Deactivation Efficiency

A direct plasma treatment (as shown in FIG. 1) with DBD was used for the testing. The direct DBD was created by a microsecond pulsed power supply which creates discrete voltage bursts at a repetition rate of 3.5 kHz which consist of decaying sinusoidal waveforms with a frequency of 32 kHz and a peak-to-peak voltage of approximately 20 kV. The gap distance between the plasma reactor and the disc was 2 mm. Spore inoculum for the stainless steel disc was prepared in 1×PBST with soil instead of sterile water. Citric acid was added to water to produce 0.01% to 1% acid solutions. 3 μl of each of these solutions was added to the spore-containing discs. After application, the discs were subjected to DBD treatment for 20 seconds or 40 seconds.

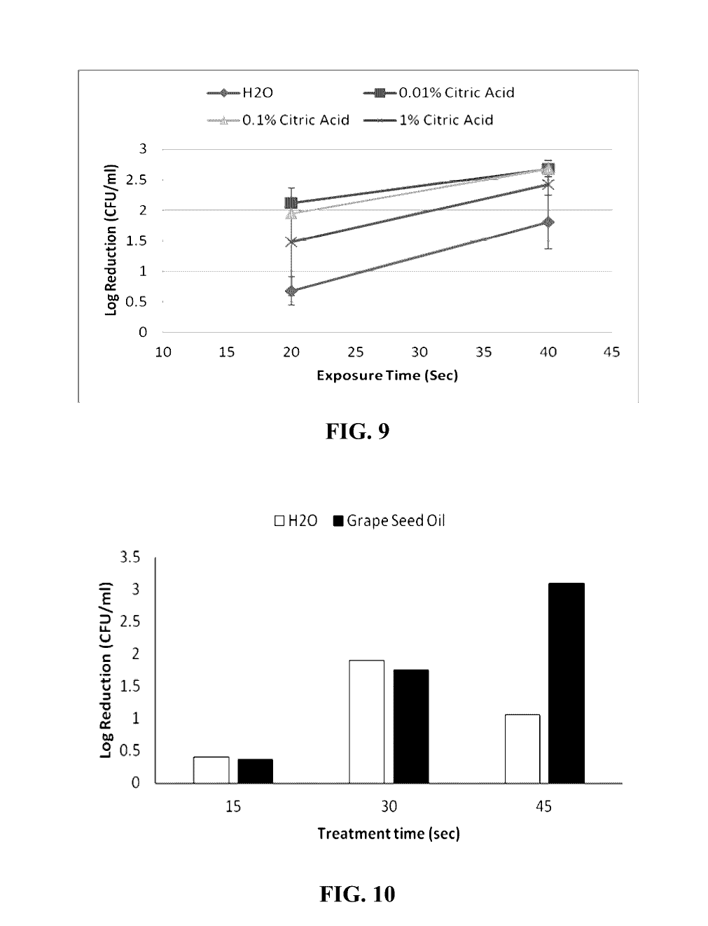

The results are shown in FIG. 9. As shown in FIG. 9, increasing exposure time from 20 to 40 seconds increased the killing or deactivation efficiency of all treatments. All of the citric acid solution treatments (triangle, square, and crosshatch lines) provided increased killing or deactivation efficiency relative to the treatment with water alone (diamond line). Surprisingly, lower concentration citric acid solution treatments (square and triangle lines) provided a greater killing or deactivation efficiency than the 1% citric acid concentration solution (crosshatch line).

### Example 6: Grape Seed Oil Increases Killing or Deactivation Efficiency

A direct plasma treatment (as shown in FIG. 1) with DBD was used for the testing. The direct DBD was created by a microsecond pulsed power supply which creates discrete voltage bursts at a repetition rate of 3.5 kHz, which consist of decaying sinusoidal waveforms with a frequency of 32 kHz and a peak-to-peak voltage of approximately 20 kV. The gap distance between the plasma reactor and the disc was 2 mm. Spore inoculum was prepared in 1×PBST instead of sterile water. Grape seed oil was added to water to produce a 1% concentration solution. 3 μl of the solution was applied to the spore-containing discs. After application, the discs were subjected to DBD treatment for 15, 30, or 45 seconds.

The results are shown in FIG. 10. As shown in FIG. 10, the addition of grape seed oil increased the killing or deactivation efficiency relative to water when DBD treatment was applied for 45 seconds.

### Example 7: EtOH Vapor Increases Killing or Deactivation Efficiency

A plasma device, which creates volumetric DBD (as shown in FIG. 2) was used for the testing. The volumetric DBD was created by an AC sinusoidal voltage power supply with a power scale at 8, a driving frequency of 22.8 kHz, and a duty cycle of 50% (power consumption was about 16 W). The gap distance between the plasma reactor and the disc was 2 mm. Spore inocula contained both PBST and soil. EtOH was added to water to produce a 70% EtOH solution. A 70% EtOH vapor was prepared from the solution by feeding compressed air (1200 standard cubic centimeters per minute or sccm) through a bubbler system. The compressed air served as the plasma working gas and the mixture of the air and vaporized EtOH was fed through the plasma zone in the plasma generator. The vapor was activated with the plasma and the activated vapor was used to treat the spore-containing disc. Treatment occurred for a period of 30 seconds.

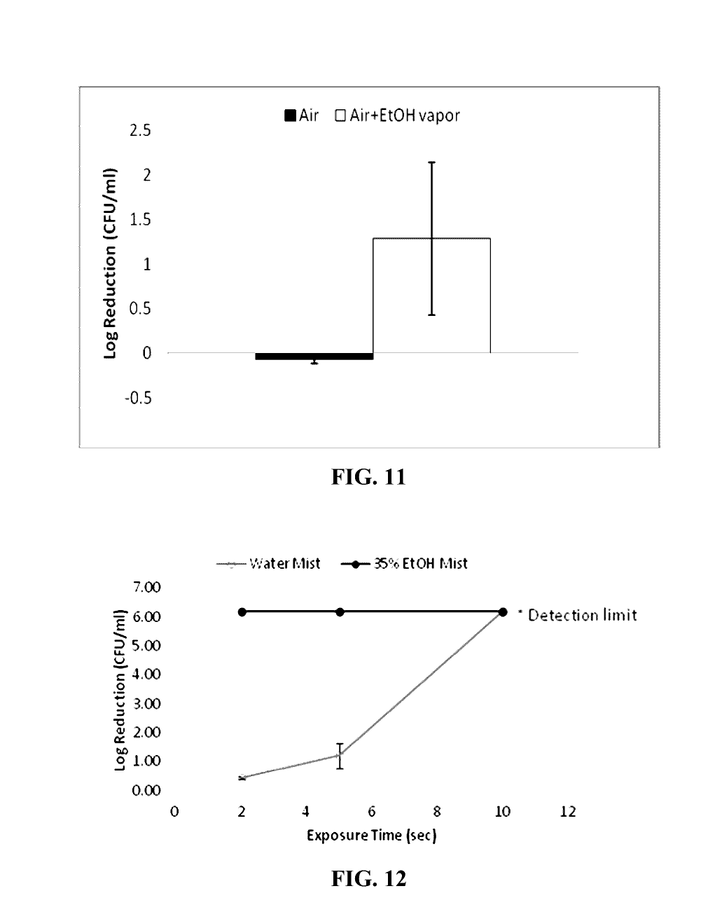

The results are shown in FIG. 11. As shown in FIG. 11, addition of EtOH vapor to the air increased killing or deactivation efficiency relative to the air alone.

### Example 8: EtOH Mist Increases Killing or Deactivation Efficiency

A cylindrical double-dielectric plasma device, which creates volumetric DBD (as shown in FIG. 2) was used for the testing. The volumetric DBD was created by an AC sinusoidal voltage power supply with a power scale at 20, a driving frequency of 24.1 kHz, and a duty cycle of 50% (power consumption was about 21 W). The gap distance between the plasma reactor and the disc was 5 mm. EtOH was added to water to produce a 35% EtOH solution. A humidifier was used to provide water alone or the 35% EtOH solution in mist form. The mist was carried by air as the plasma working gas at a flow rate of about 900 feet/minute and fed through the plasma zone of the plasma generator. The plasma treatment activated the mist and the activated mist was used to treat the spore-containing disc. Treatment occurred for a period of 2, 5, or 10 seconds.

The results are shown in FIG. 12. As shown in FIG. 12, while both the water mist (open circle) and the EtOH mist (closed circle) were able to produce a killing or deactivation efficiency at the 6 LR detection limit, that level of LR required 10 seconds of treatment with the water mist but only 2 seconds of treatment with the EtOH mist.

### Example 9: EtOH Stabilizes Reactive Species

An indirect plasma treatment (as shown in FIG. 3) with DBD was used for the testing. The indirect DBD was created by an AC sinusoidal voltage power supply with a driving frequency of 20 kHz (power consumption was about 13 W). The gap distance between the plasma reactor and the liquid surface was 1 mm. EtOH was added to water to prepare 35% and 70% EtOH solutions. 150 μl of tap water, 35% EtOH, and 70% EtOH was activated by plasma for 1 minute at room temperature. 50 μl of each of the activated solutions was applied to the spore-containing disc immediately, 3 minutes, or 5 minutes after activation. The treatment occurred for a period of 30 seconds.

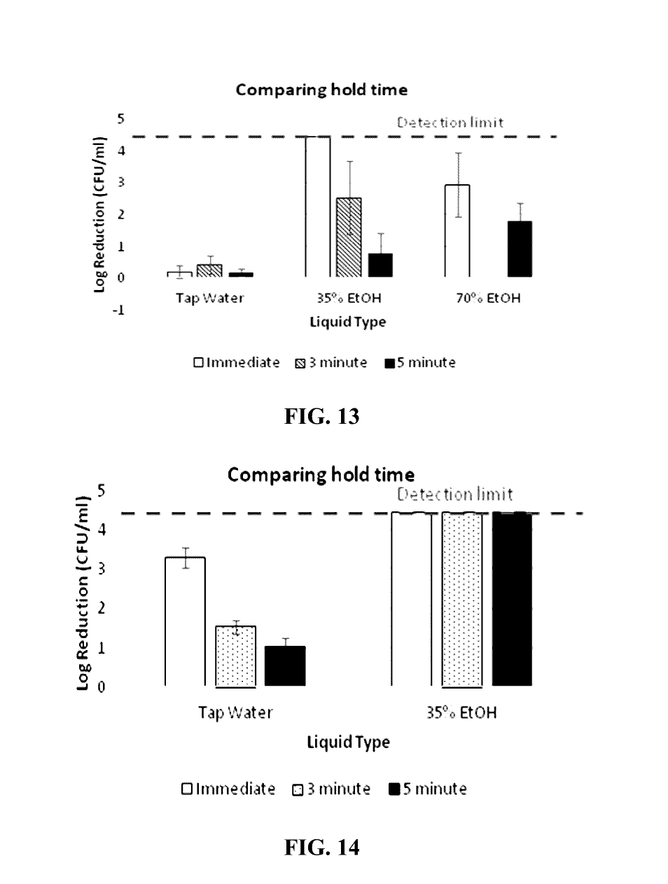

The results are shown in FIG. 13. As shown in FIG. 13, while the plasma activated tap water had a low (<0.5 LR) efficacy at any hold time, plasma activated 35% and 70% EtOH provided >4 LR and 3 LR, respectively, when the solutions were applied to the spores immediately after activation. The 35% EtOH and 70% EtOH solutions still provided a greater than 2-log and about a 2-log reduction when applied to the spore 3 and 5 minutes after activation, respectively. The results suggest that the reactive species in EtOH solutions produced through plasma activation are more stable than the reactive species produced through plasma activation of water alone. We note that the plasma activated tap water can achieve >4 LR against bacteria such E. coli. However, in this case, only <0.5 LR against C. diff spores was observed.

### Example 10: Condensed Liquid Collected from Plasma Activated EtOH Mist Stabilizes Reactive Species

An apparatus as shown in FIG. 4 coupling a double-dielectric plasma device, which creates volumetric DBD with a cold bath, was used for the testing. The volumetric DBD was created by an AC sinusoidal voltage power supply with a power scale at 10, a driving frequency of 21 kHz, and a duty cycle of 50% (power consumption was about 17 W). EtOH was added to water to prepare a 35% EtOH solution. A humidifier was used to supply water or the ethanol solution as a mist. The mist was carried by air as the plasma working gas with a flow rate of about 900 feet/minute and fed through the plasma zone of the plasma generator shown in FIG. 4. The container to collect the activated mist as a liquid was placed in a cold water-bath filled with ice (at 0° C.). About 50 μl of the collected liquid was applied to the spore-containing disc immediately, 3 minutes, or 5 minutes after 3 minutes of activated liquid collection time. The spore-containing disc was exposed to the liquid for 30 seconds.

The results are shown in FIG. 14. As shown in FIG. 14, the plasma-activated tap water prepared using this method has better efficacy (>3 LR) in killing or deactivating spores than the water prepared in example 9 (<0.5 LR) likely due to the fact that the low temperature help preserve the short-lived sporicidal species. Furthermore, the liquid collected from the 35% EtOH plasma mist has >4 LR regardless of the time after activation at which the liquid is applied to the spores. The results suggest that the reactive species in EtOH solutions produced through plasma activation are more efficacious and stable than the reactive species produced through plasma activation of water alone.

### Example 11: Reactive Species is Stabilized Even by a Low Concentration of EtOH

An indirect plasma treatment (as shown in FIG. 3) with DBD was used for the testing. The indirect DBD was created by an AC sinusoidal voltage power supply with a driving frequency of 17 kHz (power consumption was about 5.5 W/in²). The gap distance between the plasma reactor and the liquid surface was 1 mm. EtOH was added to water to prepare 0.375%, 0.75%, 1.5%, 3%, 10%, 20%, 30%, 40%, 50%, 60%, 70%, 80%, 90% and 96% EtOH solutions. 160 μl of water and the EtOH solutions with various concentrations was added to 3×3 cm² wipes and then activated by plasma for 45 seconds at room temperature. The activated wipe was used to wipe spore-containing surface immediately (2-3 seconds) after activation. The wiping time was about 4-6 seconds.

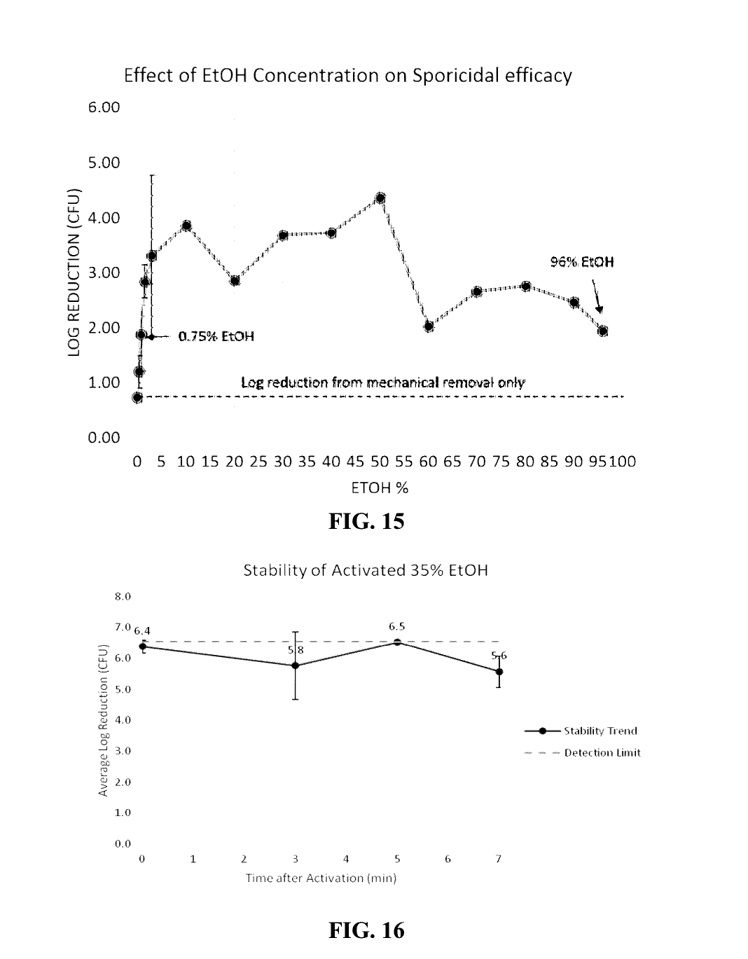

The results are shown in FIG. 15. As shown in FIG. 15, the wipe containing the plasma-activated water (0% EtOH) can only achieve 0.7 LR against C. diff spores. It should be noted that the wipe with water only or EtOH only (without plasma activation) also has ˜0.7 LR, which means the wipe itself can achieve ˜0.7 LR by just mechanical removal. This also indicated that the lifetime of the species generated from plasma activated water is not long enough (<2 seconds) to have any sporicidal effect (but it has bactericidal effect). With the addition of ≧0.75% EtOH to the water, the activated wipe can achieve ≧2 LR, which indicated the additional 1+ log was achieved by the chemical deactivation by reactive species. The results suggest that the reactive species in the solutions with EtOH addition produced through plasma activation are more efficacious and stable than the reactive species produced through plasma activation of water alone. And the EtOH concentration can be as low as 0.75% to provide the stabilization of the reactive species.

### Example 12: EtOH Stabilizes Reactive Species

An indirect plasma treatment (as shown in FIG. 3) with DBD was used for the testing. The indirect DBD was created by an AC sinusoidal voltage power supply with a driving frequency of 24 kHz (power consumption was about 13 W). The gap distance between the plasma reactor and the grounded mesh electrode was 0.5 mm. The gap distance between the grounded mesh electrode and the liquid surface was 0.75 mm. EtOH was added to water to prepare 35% EtOH solutions. 200 μl of 35% EtOH and water was activated by plasma for 2 minutes at room temperature. 50 μl of the activated solutions was applied to the spore-containing disc immediately, 1 minutes, or 3 minutes after activation. The treatment occurred for a period of 30 seconds.

The results are shown in FIG. 16. As shown in FIG. 16, the 35% EtOH solution maintained the same efficacy at 5 minutes post activation as it did immediately after activation. The results suggest that the reactive species in EtOH solutions produced through plasma activation are more stable than the reactive species produced through plasma activation of water alone and have more efficacy than activated water alone.

### Example 13: Air Plasma Operating in the Ozone Mode Needs to be Coupled with EtOH to Stabilize Reactive Species

An indirect plasma treatment (similar setup to that shown in FIG. 3) with DBD and arc was used for the testing. Both the indirect DBD and arc were created by an AC sinusoidal voltage power supply. The plasma repetition rates of the DBD and the arc were 28 kHz and 4.5 kHz, respectively. The plasma current peak and duration of the DBD were about 0.13 A and 7 ns, while those of the arc discharge were about 7 A and 15 ns. The arc discharges transferred 18 times more charges than the DBD. The DBD operated in the ozone mode, while the arc was in the NOx mode. The DBD and the arc were used to activate 200 μl of 35% EtOH by volume for 0.5, 1, 1.5, and 2 min. 50 μl of the activated solutions was applied to the spore-containing disc immediately. The treatment occurred for a period of 30 seconds.

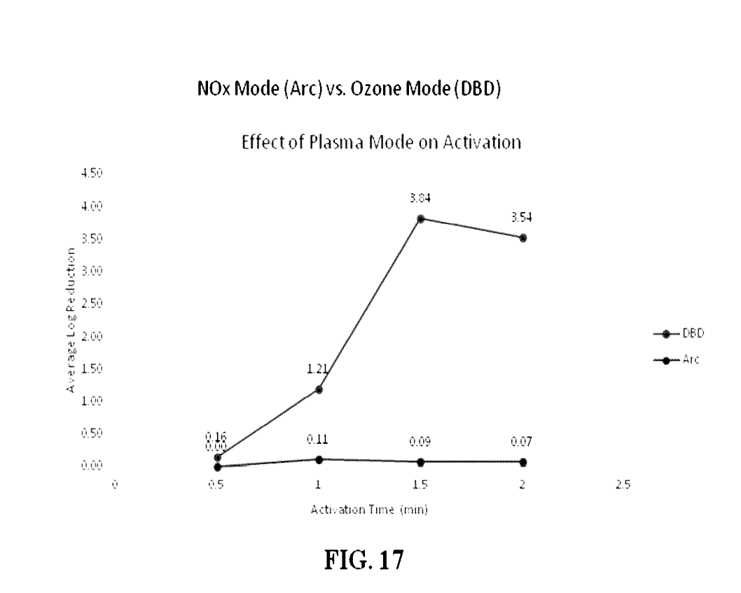

The results are shown in FIG. 17. The average log reduction is shown along the y-axis and the activation time is shown in minutes along the x-axis. As shown in FIG. 17, the 35% EtOH solution treated by DBD exhibited sporicidal efficacy (>3 LR with 1.5 min activation time), while the arc-activated solutions showed very low efficacy (<0.2 LR even with 2 min arc activation). The results suggest that the reactive species in EtOH solutions produced through arc discharge activation are not sporicidal.

Unless otherwise indicated herein, all sub-embodiments and optional embodiments are respective sub-embodiments and optional embodiments to all embodiments described herein. While the present invention has been illustrated by the description of embodiments thereof and while the embodiments have been described in considerable detail, it is not the intention of the applicants to restrict or in any way limit the scope of the appended claims to such detail. Additional advantages and modifications will readily appear to those skilled in the art. Moreover, elements described with one embodiment may be readily adapted for use with other embodiments. Therefore, the invention, in its broader aspects, is not limited to the specific details, the representative apparatus and/or illustrative examples shown and described. Accordingly, departures may be made from such details without departing from the spirit or scope of the applicants' general inventive concept.

We claim:

1. A solution for killing or deactivating a spore comprising:
water; and
a stabilizer;
wherein the solution is activated by a plasma gas to activate the solution;
wherein the plasma gas is generated in an ozone generation mode and
wherein the activated solution is activated to an activation level that is sufficient to kill or deactivate one or more spores; and
wherein the activated solution remains at an activation level that is sufficient to kill or deactivate one or more spores for at least about 30 seconds.

2. The solution of claim 1 wherein the stabilizer comprises at least about 0.75% of an alcohol by volume.

3. The solution of claim 1 wherein the stabilizer comprises at least about 35% of an alcohol by volume.

4. The solution of claim 1 wherein the ozone generation mode has the plasma power density less than 0.25 W/cm².

5. The solution of claim 1 wherein the stabilizer comprises at least about 70% of an alcohol by volume.

6. The solution of claim 1 wherein the activated solution has a pH of less than about 5.

7. The solution of claim 1 further comprising an additive.

8. The solution of claim 7 wherein the additive comprises at least one of a nitrite, a bioactive oil, an acid, a transition metal and an enzyme.

9. The solution of claim 7 wherein the additive comprises less than about 10% of the volume.

10. The solution of claim 7 wherein the additive comprises less than about 1% of the volume.

11. The solution of claim 7 wherein the additive comprises less than about 0.1% of the volume.

12. A solution for killing or deactivating a spore comprising:
water;
at least 0.75% by volume of a stabilizer; and
less than 10% by volume of an additive;
wherein one or more of the water, stabilizer and additive are activated by a plasma gas generated in an ozone generating mode; and
wherein the one or more of the water, stabilizer and additive remain activated to a level sufficient to kill one or more spores for at least 30 seconds.

13. The solution of claim 12 wherein the stabilizer is an alcohol.

14. The solution of claim 12 wherein the additive is an acid.

15. The solution of claim 12 wherein the additive is a bioactive oil.

16. A solution for killing or deactivating a spore comprising:
water;
at least 0.75% by weight of an alcohol; and
less than 10% by weight of an additive;
wherein one or more of the water, stabilizer and additive are activated by a plasma gas that is operated in an ozone generating mode.

17. The solution of claim 16 wherein the additive is citric acid.

18. The solution of claim 16 wherein the additive is an oil.

19. The solution of claim 16 wherein the solution has a pH of less than about 5 after activation.

20. The solution of claim 16 wherein the solution is in the form of a mist, a vapor, a fog, aerosol or a spray and wherein water, stabilizer and additive contain less than 1 ppm prior to being activated.
